(19) United States
(12) Patent Application Publication
(10) Pub. No.: US 2005/0005290 A1
(43) Pub. Date: Jan. 6, 2005

(54) Hyper-cell TV schedule listing representation

(76) Inventor: Yakov Kamen, Cupertino, CA (US)

Correspondence Address: Yakov Kamen, 19334 Greenwood Drive, Cupertino, CA, 95014, US

(21) Appl. No.: 10/877,675

(22) Filed: Jun. 26, 2004

Related U.S. Application Data
(60) Provisional application No. 60/484,513, filed on Jul. 3, 2003.

(51) Int. Cl. H04N 5/445; G06F 9/455; G06F 3/00

(52) U.S. Cl. 725/39; 725/44; 725/52; 725/45; 725/47; 725/56; 725/58; 725/46

(57) ABSTRACT

An electronic programming guide (“EPG”) in accordance with the invention provides a schedule listing comprising of two or more groups of event names depending on special event name group creation criteria. Each group of event names is represented differently by time proportional cells or fixed-sized cells. The EPG information display format is thus easier to navigate and review than prior art EPG formats. In one embodiment the EPG listing consists of two groups of event names: currently playing and near-future event names, and distant-future event names. All currently playing and near-future events presented as time proportional grid cells. All distant-future event names are presented as fixed-sized cells organized in channel-based lists. In one embodiment current and near-future time is defined differently for different channels and two groups can have repeated elements.

### CROSS-REFERENCE TO RELATED APPLICATIONS

This application claims the benefit of provisional patent No. 60/484,513 filed 2003 July 03 by the present inventor.

### FEDERALLY SPONSORED RESEARCH

Not applicable.

### SEQUENCE LISTING OF PROGRAM

Not applicable.

### BACKGROUND OF THE INVENTION

The present invention pertains to on-screen television schedule information visualization and presentation in digital electronic (interactive) programming guides (“EPGs”).

Most EPGs operate as follows. In an EPG, program schedule information, and sometimes applications and/or system software, are transmitted to information visualization and presentation device (“IVPD”) located on the viewer's premises by way of broadcast, cable, direct satellite or some other suitable form of transmission. IVPD may be a generic PC, digital (personal) video recorder (DVR/PVR), or set-top box (STB). The IVPD contains memory (and is in essence a dedicated computing device) so that the program schedule information can be stored for later viewing. The program schedule information stored in the IVPD is periodically updated (e.g., on a continuous, daily, weekly, or biweekly basis). A microprocessor within the IVPD cooperates with the viewer's television set to display the stored program schedule information and to implement other functions of the EPG in response to user-generated signals. The functions available depend on the sophistication of the particular EPG.

The most popular way of information presentation in an EPG is a program listing. A typical listing consists of program event names associated with the time of the event's playing or airing. Presently existing EPGs provide television viewers with on-screen television listing information in three different forms: “Grid”, “Link-list”, and “Table”.

The Grid-form (“Grid”) of a listing representation is the most popular solution in North America and the United Kingdom. The Grid is defined as a set of time-proportional rectangular cells, where each cell visualizes the TV event's title (event). U.S. Pat. No. 5,809,204 issued to Young at al., on Sep. 15, 1998, describes a method and apparatus to generate a Grid listing representation. FIG. 1 shows an example of a Grid TV listing. All events in the listing are presented in a time-proportional manner.

The Link-list-form is widely used in TiVo personal video recorders (PVRs). U.S. Pat. No. 6,642,939 issued to Vallone, et al, on Nov. 4, 2003, describes a method and apparatus to display the program guide information in two different modes: two columns or three columns. For instance, the two column mode displays the available channels in a rotating endless list fashion in the left hand column and the programs for the highlighted channel in the right hand column. FIG. 2 shows an example of a Link-list TV listing. All events in the listing are represented in the same manner.

The Table-form is widely used in magazines and printed publications outside of North America and UK. In the Table-form, TV event titles are stored in a table consisting of same-size cells organized in columns and rows. In that table each single column (or row) is associated with one particular channel. All events scheduled at the particular channel are listed in the channel's column (or raw) in order of airing. Each event title covers one single table cell. An event's length is defined by difference between current event's starting time and next event starting time. FIG. 3 shows an example of the Table-form listing presentation.

The article “Mathematical Model Of Interactive Programming Guide” written by Kamen and published on Jun. 8, 2003 in NCTA Technical Papers of the 52^{nd} Annual NCTA Convention & International Exposition, Jun. 8-11, 2003 Chicago, Ill., pp. 40-48, describes a mathematical theory that allows one to compare different forms of TV schedule listing presentation. According to this theory, the effectiveness of any listing presentation form depends on the users' ability to judge the amount of waiting time before the event is played (for one user, 3 hours of waiting time is too much, while for another it is not). This waiting time can be calculated as a time interval between the current time and the time when a particular event is scheduled to be played (aired). The article postulates that a TV event's value for the user declines as the waiting time increases, and separates all events into three clusters based on their waiting time intervals: currently playing events, near-future events, and distant-future events. For all currently playing events their waiting time is equal to zero. For all near-future events their waiting time is less than or equal to a threshold constant. For all distant-future events their waiting time is greater than the threshold constant. FIG. 4 illustrates an event's decrease in value as a function of waiting time. The article describes that any Grid-form schedule data representation is effective at displaying current and near-future events and ineffective at displaying distant-future events. For the Link-list-form the situation is reversed: Link-list-forms are effective at describing distant-future events and ineffective at describing current and near-future events. The Table-based form is relatively ineffective in both cases.

The major disadvantage of all existing solutions is based on the fact that the events are presented the same way for current, near-future, and distant-future events. The novelty of the current invention is to use different methods of schedule data representation for different events based on their waiting time.

### SUMMARY

A TV schedule listing in accordance with one embodiment of this invention comprises two groups of TV event names defined by an event name group creation criterion. The first group comprises of event names that relate to the currently playing (airing) events or events that will be played in the near-future. This group of event names is represented in Grid-form and is listed in a set of time proportional cells. The second event name group consists of event names that relate to events that will be played in the distant-future. This group of event names is represented in Link-list-form and is listed in a set of fix-size cells.

In one embodiment, the event name group creation criteria uses near-future and distant-future time to define event name groups.

In one embodiment event name group creation creates overlapping groups

In one embodiment the concepts of near-future and distant-future are different for different TV channels. The EPG at any chosen time interval can be covered by time proportional and time independent cells.

In one embodiment the concepts of near-future and distant-future change dynamically, and two sets of cells can vary dynamically.

In one embodiment multiple time intervals are added between the current time and distant-future time. In that case a more complex combination of different cell sets can be used.

These and other features of the invention are described in greater detail below.

### BRIEF DESCRIPTION OF THE DRAWINGS

FIG. 1 shows a Grid-form TV schedule listing

FIG. 2 shows a Link-list-form TV schedule listing

FIG. 3 shows a Table-based form TV schedule listing

FIG. 4 shows an event's value degradation process as a function of waiting time.

FIGS. 5A to 5C show various implementations of the “Hyper-Cell” EPG solution

FIG. 6 shows a block diagram of a television system in accordance with the present invention.

### DETAILED DESCRIPTION

This invention relates to an EPG system that provides the user with schedule information for broadcast programs (including cablecast, or datacast programs) viewed by the user on a television or a PCTV. (A PCTV is a personal computer having the capability of displaying video programs.) This invention also relates to an improved EPG that uses a 3D graphics pipeline to display images, alphanumeric text and video data and provides the user with a more powerful and convenient television in a desktop environment, while simultaneously increasing the efficiency of navigation by the user through the EPG.

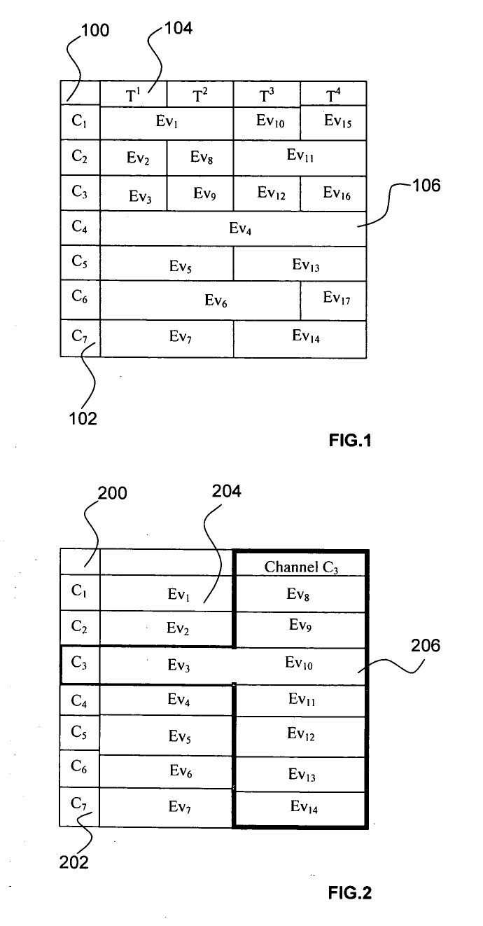

FIG. 1 shows an example of a Grid-form TV schedule listing 100 comprising of five columns: the first “channel names” column 102, and four “time” columns 104. Four time columns present seventeen time proportional event names 106. On FIG. 1 they are named from Ev₁ to Ev₁₇. Usually a single time column represents a thirty minute time interval. In many real systems the number of rows is equal to the number of listed channels and the number of columns is calculated as 2×N, where N is the number of hours of schedule available to the user.

FIG. 2 is an example of a Link-list-form TV schedule listing 200 consisting of three columns. The first “channel name” column 202 consists of seven channel names. The second “current time” column 204 consists of seven currently playing event names Ev₁, Ev₂, Ev₃, Ev₄, EV₅, Ev₆, and Ev₇. The third Link-list” column 206 consists of seven event names Ev₈, Ev₉, Ev₁₀, Ev₁₁, Ev₁₂, Ev₁₃, and Ev₁₄. All cells are of a fixed size and independent of the event's length. In many real systems the number of rows is equal to the number of listed channels and number of columns is calculated as 2×N, where N is the number of hours of schedule available to the user.

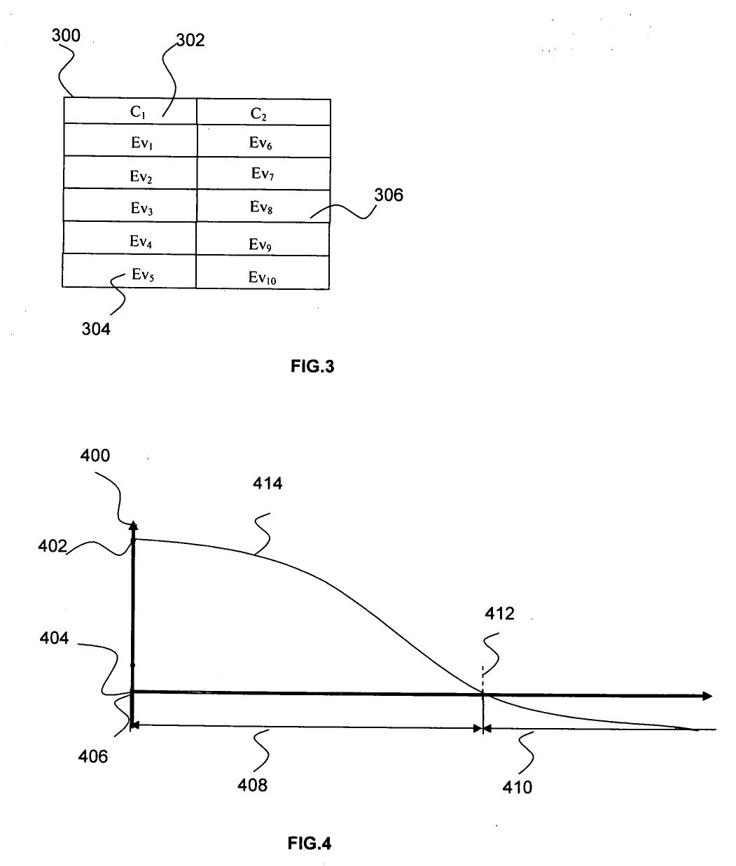

FIG. 3 is an example of a Table-form TV schedule listing 300 consisting of two columns. Each column 304 consists of fixed-sized cells. Channel name cells 302 display names of channels. Other cells 304, 306 show names of TV events Ev₁, . . . ,Ev₁₀ playing on each channel. These names are ordered by time. In many real TV listing tables, the number of columns is equal to the number of listed channels M and the number of rows is calculated as max(a₁, . . . , a_{M}), where aⱼ is the number of events available in the listing for the channel “J”.

FIG. 4 shows an event's value degradation process as a function of waiting time. On the chart 400
point 402 is the point of maximum value of the event;
point 404 is the point of minimum value of the event;
point 406 is the zero waiting time point;
interval 408 is the near-future time interval;
interval 410 is the distant-future time interval;
point 412 is the threshold point between near-future and distant-future;
curve 414 is the value degradation curve.

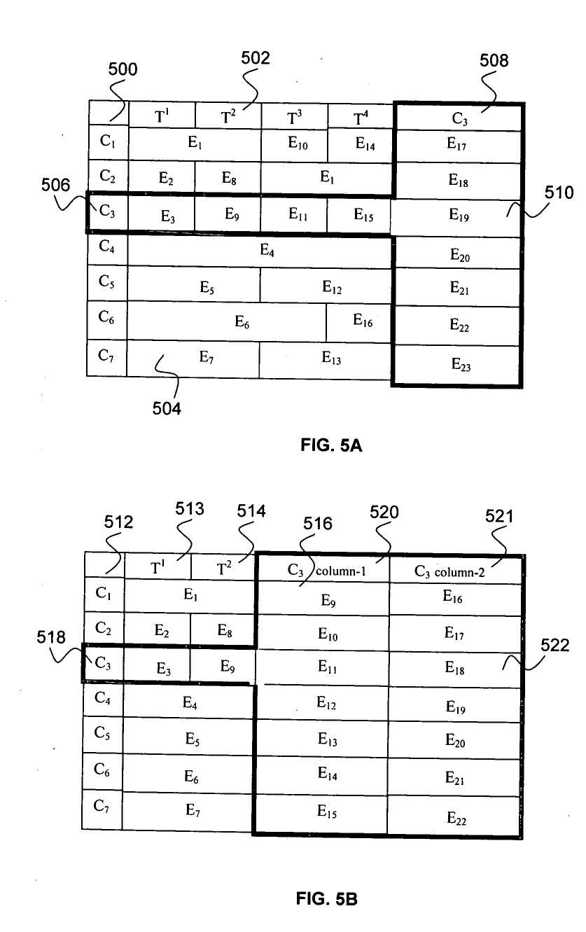

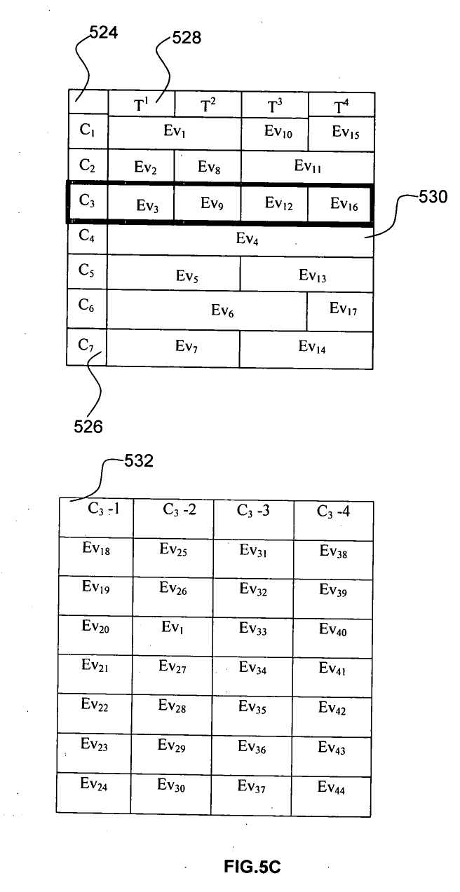

FIG. 5A describes a preferred embodiment of the invention. According to this embodiment all event names are separated by an event name group creation criterion into two non-intersecting groups:
group of current and near-future events;
group of distant-future events.
   The event name group creation criteria divides the time associated with each event name (usually it is the event's starting time) into current and near-future time and distant-future time. The event name group creation criteria can be generated based on the event value degradation function shown on FIG. 4. The current and near-future event group includes all event names of events that are either currently playing or will be playing at a near-future time. In practice a general event listing is long and is routinely subdivided into a set of pages. FIG. 5A shows a single page of the patented listing. On the listing page 500 the current and near-future time is covered by four fixed-sized (“basic”) time intervals 502 marked as T¹, T², T³, and T⁴. On this page 500 events E₁, . . . ,E₁₆ represent the current and near-future event group 504 for the seven visible channels C₁, C₂, C₃, C₄, C₅, C₆, C₇. The distant-future event group 508 includes all events E₁₇, . . . ,E₂₃ that will played in the future. All current and near-future events 506 are time-proportionally presented. All distant-future events 510 are presented in a fixed-sized list.

The operational navigation of the listing can be done as follows: when the focus is located on the channel 506 the list 508 is refreshed and filled with distant-future event names ordered by playing time. When the focus is changed to a different channel the list 508 is refreshed again and is filled with distant-future events for that channel.

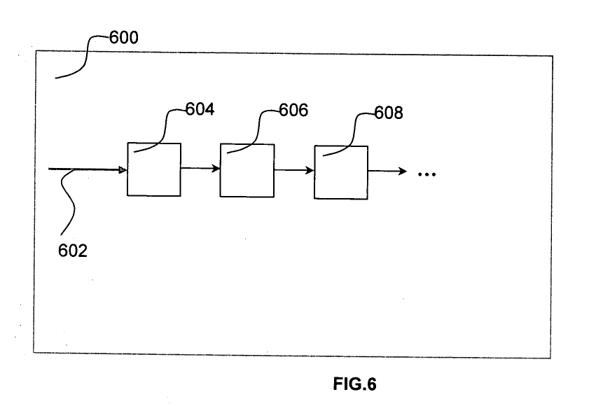

FIG. 6 shows a schematic of an apparatus 600 that operates the preferred embodiment. The set of all event names 602 is entered into an event separation block 604. This block separates entered event names into two groups: current and near-future events and distant-future events. The block's 604 output is connected to the input of a navigation management block 606. The block 606 controls interactive requests for navigation, for instance, requests to move focus up, down, left, and right, requests to change pages, and show event descriptions, etc. The output of the navigation management block 606 is connected to the input of the distant-future event preparation block 608. For the channel that is “focused” the block 608 aggregates distant-future event names, positions these names in the right order, and truncates long names when necessary.

Additional Embodiments.

Another embodiment of the invention is shown in FIG. 5B. In this embodiment, distant-future events 522 occupy two columns 520 and 521 and the current and near-future group and distant-future group have common elements 516. The current and near-future time consists of two time intervals 513 and 514.

Another embodiment of the invention is shown on FIG. 5C. In this embodiment the whole page 524 is completely covered by current and near-future events 530. All of these events are represented as a time-proportional grid. The second page 532 represents distant-future events that are represented in a four column regular fixed-sized table.

Accordingly, the reader will see that hyper-cell listing representation of this invention can be used to present schedule data more effectively than ever before. Furthermore, a hyper-cell listing representation has the additional advantages in that:
it permits hardware manufacturers to develop next generation products;
it is naturally optimized for EPGs in digital personal video recorders.

Although the description above contains much specificity, this should not be construed as limiting the scope of the invention but as merely providing illustrations of some presently preferred embodiments of this invention.

1. A method of presenting programming information, comprising:
subdivision of all programming event names into multiple groups; and
assignment of one type of listing visualization to each said group; and
displaying each said group in a chosen type of said listing visualization at the device screen.

2. The method of claim 1 wherein said programming event name belongs to a single group.

3. The method of claim 1 wherein said groups are chosen based on event associated time according to a pre-defined event waiting time criterion.

4. The method of claim 1 wherein said groups are two groups chosen by separating the event's associated time into two time categories: current and near-future time and distant-future time.

5. The method of claim 1 wherein said groups are two groups chosen by separating event's associated time into two time categories: current and near-future time and distant-future time and displaying one said group in time-proportional cells and other said group in fixed-sized cells.

6. The method of claim 1 wherein said groups are two groups defined differently for different channels; and displaying one said group in time-proportional cells and other said group in fix-size cells.

7. An apparatus comprising:
a screen for displaying a video program; and
an electronic program guide for displaying time associated program information on a window within said screen while a video program is displayed another portion of said screen outside of said window; and
a program listing for displaying names of time associated programs.

8. The apparatus of claim 7 wherein said program listing comprises of two groups of event names; and one said group of event names is visualized in time proportional cells; and other said group of events name is visualized in fixed size cells.

9. The apparatus of claim 8 wherein said groups are defined based on an event name group creation criterion.

10. The apparatus of claim 9 wherein said event name group creation criterion is a function of time associated with said event names.

11. The apparatus of claim 10 wherein said event name group creation criterion is a function of said current and near-future time and said distant-future time.

12. The apparatus of claim 9 wherein said event name group creation criterion is defined differently for different said event groups.

13. The apparatus of claim 9 wherein said event name group creation criterion is defined differently for different channels.

14. The apparatus of claim 11 wherein said criterion is defined differently for different said channels.

15. The apparatus of claim 7 wherein said program listing comprises multiple groups of event names; and each said group of event names is defined by said event name group definition criterion; and each said group is visualized in a different format.

16. The apparatus of claim 15 wherein said visualization format set includes said time proportional cells, and said fixed size cells.

17. The apparatus of claim 15 wherein said event name group definition criterion is a function of time associated with said event names.

18. The apparatus of claim 15 wherein said event name group definition criterion is a function of said current and near-future said distant-future time.

19. The apparatus of claim 15 wherein said event name group creation criterion is defined differently for different event groups.

20. The apparatus of claim 19 wherein said event name group creation criterion is defined differently for different channels.
